(19) United States
(12) Patent Application Publication
(10) Pub. No.: US 2011/0293893 A1
(43) Pub. Date: Dec. 1, 2011

(54) DECORATION FOR WALL OF BUILDING

(76) Inventors: Hun Jang, Gyeonggi-do (KR); Yeon Ja Kim, Seoul (KR); Hong Sek Jang, Seoul (KR); Young Su Jang, Seoul (KR)

(21) Appl. No.: 13/147,031

(22) PCT Filed: Nov. 29, 2010
(86) PCT No.: PCT/KR2010/008478

§ 371 Date: Jul. 29, 2011

(30) Foreign Application Priority Data
Dec. 16, 2009 (KR) 10-2009-0125289

(51) Int. Cl. B32B 3/30

(52) U.S. Cl. 428/172

(57) ABSTRACT

Disclosed herein is a decorative material installed on a building wall. The decorative material of the building wall includes: a plurality of semicircular unit parts (10); and a rectangular base board (20), to which the unit parts are adhered in a certain pattern. Each of the semicircular unit parts (10), which is made of one of roof tiles, tiles, bricks, stones, marble, wood, and plastics, has grooves (11) formed in both ends thereof, and is adhered to the base board (20) after an adhesive material (30) is put into the grooves (11) of the unit parts (30). The decorative material prefabricated through the above is constructed on the surface of the building wall.

### TECHNICAL FIELD

The present invention relates to a decorative material for a building wall, and more particularly, to a decorative material for a building wall, which is prefabricated by adhering unit parts to a base board with an adhesive material without being directly fabricated in a construction site and then is installed on the surface of the building wall in the construction site, thereby providing the building wall with a beautiful and eco-friendly decoration.

### BACKGROUND ART

In general, stone panels made of bricks, granite, or marble are widely used as decorative materials for external masonry of a building, but such stone panels were constructed on building walls by pouring cement or mortar onto the stone panels and the building walls because the stone panels are weak in tensile strength. However, these days, in order to enhance durability of stone boards, the trend is that the dry system or drywall fixing using dry decoration fixtures which are easily constructable is used.

However, in the case that external walls of a building are constructed using the stone panels made of granite or marble as the decorative materials, it has several problems in that it is difficult to construct due to their heavy weight, it takes a long time to construct, the building may have cracks in the external walls even by the slightest mistakes due to excessive load acting even after the construction and it may cause reconstruction, and expensive construction costs are required because the stone panels, which are decorations, are high-priced.

Moreover, in case of constructing the interior and exterior walls of the building through the above construction method, only engineers having years of experiences and technologies can do the construction, and hence, it is very difficult to supply and demand technical professionals.

Furthermore, recently, because renovation of buildings according to consumers' preferences has been on the rise, a method of constructing decorative materials, which can provide a neat outward appearance of interior and exterior walls of a building in various ways without needing excessive expenses, is required.

As one of various decorations for the exterior or interior walls, recently, roof tiles to show a natural figure have been used.

The roof tile decoration is made through the steps of splitting roof tiles into a plurality of small pieces, installing a base frame on the surface of a wall, on which the roof tile pieces will be decorated, and piling up the roof tile pieces in order from the lower portion of the inside of the base frame. In this instance, when the roof tile pieces are piled up, they are fixed on the surface of the building wall in a state where mortar is stained on end portions of the roof tile pieces.

However, such a method has several problems in that it takes a great deal of time and effort and the shape of the roof tile decoration may be varied according to worker's skills and techniques because the roof tile pieces must be made and piled up in the construction site one by one depending on situations of the construction site.

Moreover, such a method has other problems in that it cannot provide a harmonious feeling and may fail to satisfy the esthetic sense because different workers make different and irregular patterns.

Furthermore, in the case that the roof tile decorations are made in the construction site, various patterns cannot be made under circumstances or conditions of the construction site, and most of the roof tile decorations are a rainbow pattern formed by piling up the roof tile pieces.

Accordingly, the construction method of making the roof tile decoration in the construction site has the above problems in that construction costs are increased because it takes a lot of time and manpower and a construction period is also increased.

In order to overcome the above-mentioned problems, the inventor of the present invention had filed a Korean patent application entitled “Structure and construction method of fixing a base board to a building wall”, wherein a plurality of roof tile pieces are previously adhered to the base board and the base board to which the roof tile pieces are adhered is fixed to the building wall. However, the construction method has a problem in that it cannot create a beautiful appearance of the building wall because an adhesive material made of silicon or epoxy is exposed to the outside when the roof tile pieces are adhered to the base board.

### DETAILED DESCRIPTION

### Technical Problems

Accordingly, the present invention has been made to solve the above-mentioned problems occurring in the prior arts, and it is an object of the present invention to provide a decorative material for a building wall, which can provide a high quality of a product because a plurality of unit parts made of roof tiles, tiles or others are previously adhered to a base board, such as a marble board or a roof tile board, in such a way that an adhesive material is not exposed to the outside.

### Technical Solutions

To solve the objective, the present invention provides a decorative material of a building wall including: a plurality of semicircular unit parts made of one of roof tiles, tiles, bricks, stones, marble, wood, and plastics; and a rectangular base board, to which the unit parts are adhered in a certain pattern, wherein each of the semicircular unit parts has grooves formed at both ends thereof, and are adhered to the base board after an adhesive material is put into the grooves of the unit parts.

Alternatively, not the unit parts but the base board has grooves for putting the adhesive material thereinto, and the unit parts are fixed to the base board after the adhesive material is put into the grooves of the base board.

### Advantageous Effects

Based on the above structure, the decorative material of the building wall can provide a beautiful appearance to the building wall when it is constructed on the building wall because the unit parts, such as roof tile pieces, are adhered to the base board in such a way that the adhesive material made of silicon or epoxy is not exposed to the outside.

Moreover, the present invention can express various kinds of patterns because various materials, such as roof tiles, tiles, bricks, marble, wood, and so on, can be used.

### BRIEF DESCRIPTION OF DRAWINGS

FIG. 1 is a view showing a structure of unit parts used for a decorative material of a building wall according to a preferred embodiment of the present invention;

FIG. 2 is a perspective view showing structures of a plurality of unit parts and a base board used for the decorative material of the building wall;

FIG. 3 is a view showing a state where the unit parts are adhered to the base board;

FIG. 4 is a bottom perspective view showing the structures of the unit parts and the base board;

FIG. 5 is a sectional view showing a structure that the unit parts are adhered to the base board;

FIG. 6 is a view showing a structure of unit parts used for a decorative material of a building wall according to another preferred embodiment of the present invention;

FIG. 7 is a view showing a structure that the unit parts of FIG. 6 are adhered to the base board; and

FIGS. 8 to 10 showing a state where a plurality of unit parts are adhered to a base board used for a decorative material of a building wall according to a further preferred embodiment of the present invention.

### BEST MODES FOR PRACTICING INVENTION

Hereinafter, Reference will be now made in detail to the preferred embodiment of the present invention with reference to the attached drawings.

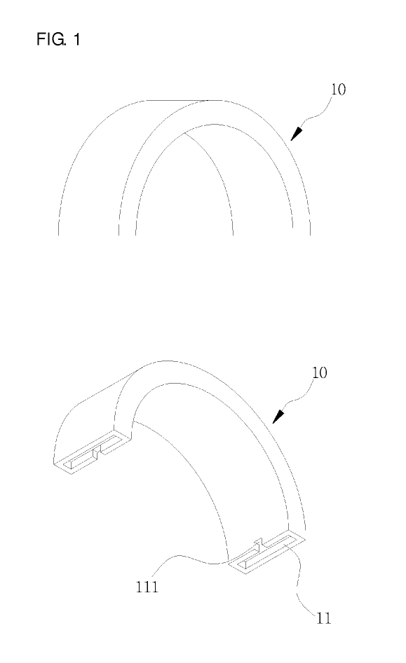

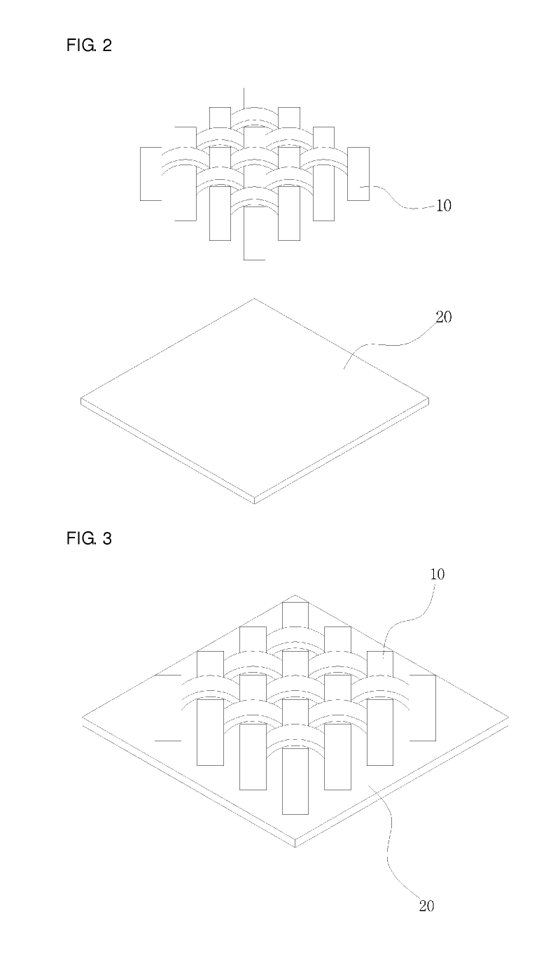

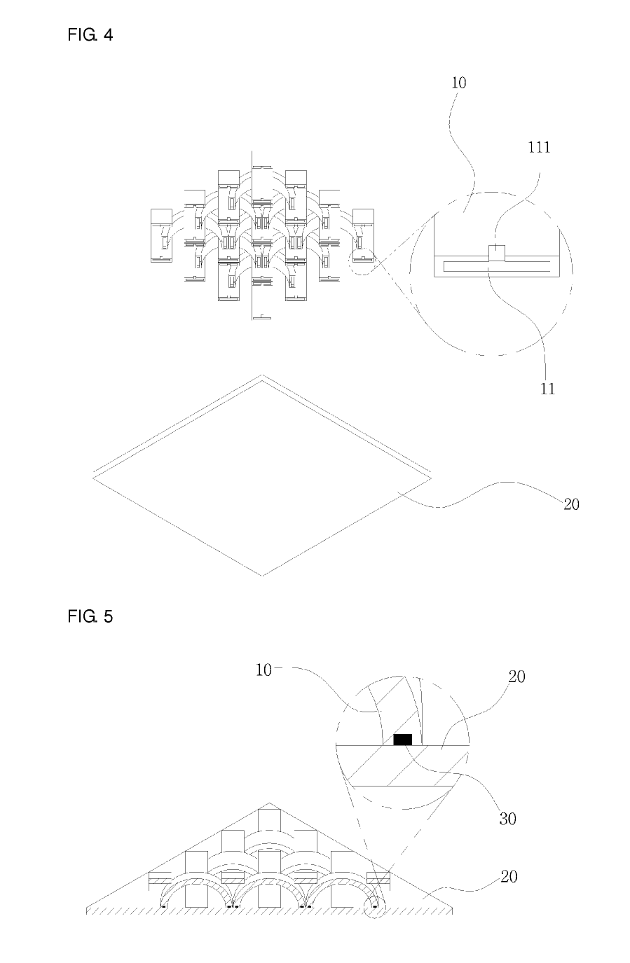

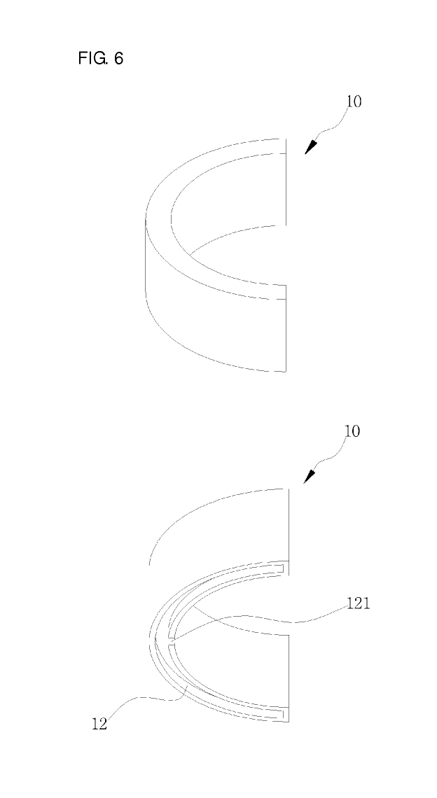

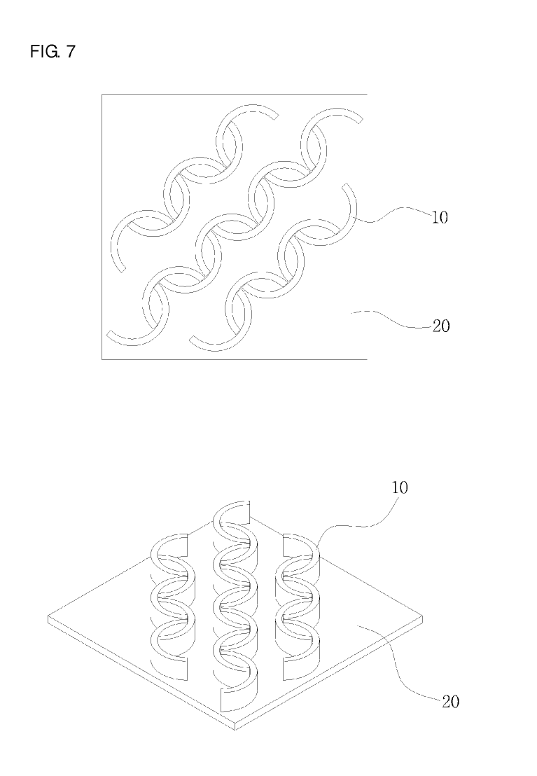

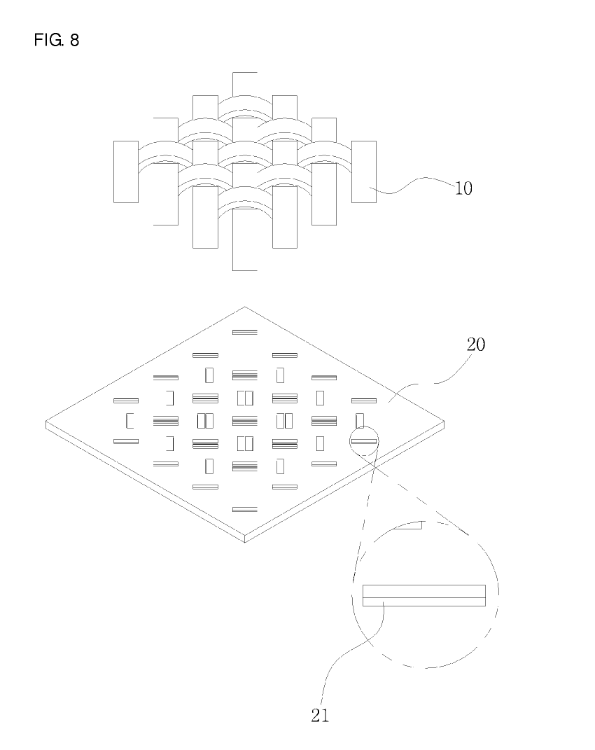

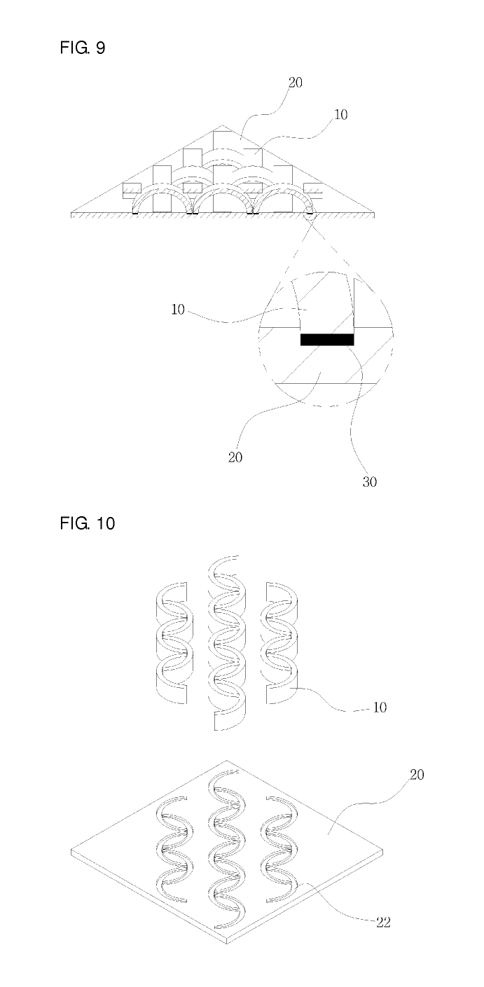

FIG. 1 is a view showing a structure of unit parts used for a decorative material of a building wall according to a preferred embodiment of the present invention, FIG. 2 is a perspective view showing structures of a plurality of unit parts and a base board used for the decorative material of the building wall, FIG. 3 is a view showing a state where the unit parts are adhered to the base board, FIG. 4 is a bottom perspective view showing the structures of the unit parts and the base board, FIG. 5 is a sectional view showing a structure that the unit parts are adhered to the base board, FIG. 6 is a view showing a structure of unit parts used for a decorative material of a building wall according to another preferred embodiment of the present invention, FIG. 7 is a view showing a structure that the unit parts of FIG. 6 are adhered to the base board, and FIGS. 8 to 10 showing a state where a plurality of unit parts are adhered to a base board used for a decorative material of a building wall according to a further preferred embodiment of the present invention.

It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

In order to overcome the problems of the prior arts that it takes much time and construction costs are increased because the roof tile decorations are directly installed on the building wall in the construction site and that the esthetic sense is deteriorated due to the irregular patterns of the roof tile decorations, the present invention provides a construction of a building wall, which can form even patterns that are difficult to be made in the construction site, and which is just installed on the surface of a building wall in the construction site after being prefabricated.

Referring to FIGS. 1 to 5, the decorative material of the building wall according to the present invention has a structure that a plurality of semicircular unit parts 10 are adhered to a rectangular base board 20 in such a way as to have various patterns.

In this instance, each of the semicircular unit parts 10 has grooves 11 formed at both ends thereof, and the unit parts 10 are adhered to the base board 20 after an adhesive material 30 is put into the grooves 11 of each unit part 10.

Particularly, each of the grooves 11, to which the adhesive material 30 is put, has a stepped groove 111 formed in the inner face thereof, and hence, the adhesive material 30 is not exposed to the outside but inserted into the stepped groove 111.

The adhesive material 30 may be made of silicon or epoxy, and the unit parts 10 may be made of one of roof tiles, tiles, bricks, stones, marble, wood, plastics, glass, steel, and so on.

As shown in FIGS. 6 and 7 illustrating another preferred embodiment of the present invention, each of the semicircular unit parts 10 has an arc-shaped groove 12 that is formed in a lower portion thereof and has a stepped groove 121 therein. The arc-shaped grooves 12 of the unit parts 10 are coated with the adhesive material 30, and then, the unit parts 10 are adhered to the base board 20 in various patterns.

Furthermore, as a further preferred embodiment of the present invention, not the unit parts 10 but the base board 20 has grooves 21 for putting the adhesive material 30 thereinto to thereby adhere and fix the unit parts 10 to the base board 20.

In other words, referring to FIGS. 8 to 10, the base board 20 has the grooves 21 and arc-shaped grooves 22, which are coated with the adhesive material 30, and a plurality of the unit parts 10 are mounted on the base board 20 in such a way that both end portions or the lower end portions of each unit part 10 are inserted and fixed into the grooves 21 of the base board 20, whereby the decorative material of the building wall according to the present invention can provide a high quality and a beautiful appearance because the adhesive material is not exposed to the outside.

1. A decorative material for a building wall, which includes a plurality of semicircular unit parts (10) and a rectangular base board (20) to which the unit parts are adhered in a certain pattern, the base board being installed on the building wall,
wherein the base board (20) comprises grooves (21) for putting an adhesive material (30) thereinto to adhere and fix the unit parts (10) to the base board (20).
